(19) United States
(12) Patent Application Publication
(10) Pub. No.: US 2022/0350869 A1
(43) Pub. Date: Nov. 3, 2022

(54) USER AUTHENTICATION METHOD AND DEVICE FOR EXECUTING SAME

(71) Applicant: Samsung Electronics Co., Ltd., Suwon-si (KR)

(72) Inventors: Dmytro PROGONOV, Kyiv (UA); Oleh SYCH, Kyiv (UA); Pavlo KOLESNICHENKO, Kyiv (UA); Valentyna CHERNIAKOVA, Kyiv (UA); Andriy OLIYNYK, Kyiv (UA); Veronika PROKHORCHUK, Kyiv (UA); Yevhenii YAKISHYN, Kyiv (UA)

(21) Appl. No.: 17/865,888

(22) Filed: Jul. 15, 2022

Related U.S. Application Data
(63) Continuation of application No. PCT/KR2020/008552, filed on Jun. 30, 2020.

(30) Foreign Application Priority Data
Jan. 22, 2020 (KR) 10-2020-0008749

(51) Int. Cl. G06F 21/31; G06F 11/34; G06F 11/30; G06N 20/00

(52) U.S. Cl. CPC G06F 21/316; G06F 11/3438; G06F 11/3051; G06N 20/00

(57) ABSTRACT

A user authentication method, by which a device authenticates a user, is provided. The user authentication method includes performing basic authentication based on a received user input, obtaining behavioral characteristics with which the user uses the device, and when the user has passed the basic authentication, performing additional authentication for the user by applying the obtained behavioral characteristics to a first learning model, wherein the first learning model is a model trained to perform the additional authentication for the user, based on at least one of a plurality of behavioral characteristics of an authenticated user, the behavioral characteristics being accumulated in the device.

### CROSS-REFERENCE TO RELATED APPLICATION(S)

This application is a continuation application, claiming priority under § 365(c), of an International application No. PCT/KR2020/008552, filed on Jun. 30, 2020, which is based on and claims the benefit of a Korean patent application number 10-2020-0008749, filed on Jan. 22, 2020, in the Korean Intellectual Property Office, the disclosure of which is incorporated by reference herein in its entirety.

### BACKGROUND

### 1. Field

The disclosure relates to a user authentication method and a device for executing the same. More particularly, the disclosure relates to a method in which, when a user has passed basic authentication, such as password input or face recognition, additional authentication is performed based on at least one of behavioral characteristics with which a user uses a device, and to a device for executing the method.

### 2. Description of Related Art

As dependence on electronic apparatuses increases in daily life, security of electronic apparatuses has become important for privacy protection or transaction safety protection.

However, requiring an input for additional authentication from a user to enhance security may reduce user convenience.

The above information is presented as background information only to assist with an understanding of the disclosure. No determination has been made, and no assertion is made, as to whether any of the above might be applicable as prior art with regard to the disclosure.

### SUMMARY

The search for methods of enhancing security without requiring an input for additional authentication from a user is underway.

Aspects of the disclosure are to address at least the above-mentioned problems and/or disadvantages and to provide at least the advantages described below. Accordingly, an aspect of the disclosure is to provide a user authentication method by which a device authenticates a user, the user authentication method including performing basic authentication based on a received user input, obtaining behavioral characteristics with which the user uses the device, and when the user has passed the basic authentication, performing additional authentication for the user by applying the obtained behavioral characteristics to a first learning model, wherein the first learning model is a model trained to perform the additional authentication for the user, based on at least one of a plurality of behavioral characteristics of an authenticated user, the behavioral characteristics being accumulated in the device.

Security may be enhanced without requiring an input for additional authentication from a user.

Additional aspects will be set forth in part in the description which follows and, in part, will be apparent from the description, or may be learned by practice of the presented embodiments.

In accordance with an aspect of the disclosure, a user authentication method by which a device authenticates a user is provided. The user authentication method includes performing basic authentication based on a received user input, obtaining behavioral characteristics with which the user uses the device, and when the user has passed the basic authentication, performing additional authentication for the user by applying the obtained behavioral characteristics to a first learning model, wherein the first learning model is a model trained to perform the additional authentication for the user, based on at least one of a plurality of behavioral characteristics of an authenticated user, the behavioral characteristics being accumulated in the device.

According to the above user authentication method, the obtaining of the behavioral characteristics with which the user uses the device and the performing of the additional authentication for the user may be performed in a background not requiring an additional action from the user.

According to the above user authentication method, the behavioral characteristics with which the user uses the device may be obtained from at least one of at least one sensor, a user interface, or an application.

According to the above user authentication method, the behavioral characteristics with which the user uses the device may include at least one of a keyboard typing pattern, a keyboard heat map, a small motion while typing or swiping, a typing timing, a touch screen swiping pattern, a touch input pattern, a context-dependent motion characteristic, behavioral information obtained through an acceleration sensor or a gravity sensor, an application usage habit, or a device grip pattern.

The above user authentication method may further include, when there is an error in a result of performing the additional authentication, updating the first learning model.

According to the above user authentication method, the plurality of behavioral characteristics of the authenticated user, accumulated in the device, may be obtained automatically when the authenticated user uses the device or manually according to a user input of the authenticated user.

According to the above user authentication method, the first learning model may be a model trained to perform the additional authentication for the user, based on at least one of context information and the plurality of behavioral characteristics of the authenticated user, accumulated in the device, and the context information may refer to at least one of a movement state of the user, a posture of the user, a location in which the user authentication is performed, or a time when the user authentication is performed.

The performing of the additional authentication for the user by applying the obtained behavioral characteristics to the first learning model may include obtaining context information about a situation in which the user authentication is performed, and determining a behavioral characteristic of the user appropriate for the obtained context information.

According to the above user authentication method, a weight may be assigned to each of the plurality of behavioral characteristics of the authenticated user, accumulated in the device.

In accordance with another aspect of the disclosure, a user authentication device is provided. The device includes an inputter configured to receive a user input for basic authentication from a device user, a memory storing one or more instructions, and a processor configured to execute the one or more instructions to obtain behavioral characteristics with which the user uses the device, and when the user has passed the basic authentication, perform additional authentication for the user by applying the obtained behavioral characteristics to a first learning model, wherein the first learning model is a model trained to perform the additional authentication for the user, based on at least one of a plurality of behavioral characteristics of an authenticated user, the behavioral characteristics being accumulated in the device.

According to the above user authentication device, the processor may be further configured to obtain the behavioral characteristics with which the user uses the device, as a background operation not requiring an additional action from the user, and perform the additional authentication for the user.

According to the above user authentication device, the behavioral characteristics with which the user uses the device may be obtained from at least one of at least one sensor, a user interface, or an application.

The behavioral characteristics with which the user uses the device may include at least one of a keyboard typing pattern, a keyboard heat map, a small motion while typing or swiping, a typing timing, a touch screen swiping pattern, a touch input pattern, a context-dependent motion characteristic, behavioral information obtained through an acceleration sensor or a gravity sensor, an application usage habit, or a device grip pattern.

According to the above user authentication device, the processor may be further configured to, when there is an error in a result of performing the additional authentication, update the first learning model.

According to the above user authentication device, the plurality of behavioral characteristics of the authenticated user, accumulated in the device, may be obtained automatically when the authenticated user uses the device or manually according to a user input of the authenticated user.

According to the above user authentication device, the first learning model may be a model trained to perform the additional authentication for the user, based on at least one of context information and the plurality of behavioral characteristics of the authenticated user, accumulated in the device, and the context information may refer to at least one of a movement state of the user, a posture of the user, a location in which the user authentication is performed, or a time when the user authentication is performed.

The processor may be further configured to obtain context information about a situation in which the user authentication is performed, and determine a behavioral characteristic of the user appropriate for the obtained context information.

The processor may be further configured to assign a weight to each of the plurality of behavioral characteristics of the authenticated user, accumulated in the device.

Another aspect of the disclosure is to provide a computer program product that, when executed, causes execution of the above user authentication method.

Another aspect of the disclosure is to provide a computer-readable recording medium having recorded thereon the above computer program product.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a structural diagram of a device for performing user authentication, according to an embodiment of the disclosure;

FIG. 2 is a flowchart of a method for performing user authentication, according to an embodiment of the disclosure;

FIG. 3 is a block diagram of a processor according to an embodiment of the disclosure;

FIG. 4A is a block diagram of a data trainer according to an embodiment of the disclosure;

FIG. 4B is a block diagram of a data identifier according to an embodiment of the disclosure;

FIG. 5 is a diagram illustrating an example of user behavioral characteristics, according to an embodiment of the disclosure;

FIG. 6 is a diagram illustrating an example of user behavioral characteristics, according to an embodiment of the disclosure;

FIG. 7 is a diagram illustrating an example of user behavioral characteristics, according to an embodiment of the disclosure;

FIG. 8 is a diagram illustrating an example of user behavioral characteristics, according to an embodiment of the disclosure;

FIG. 9 is a diagram illustrating an example of user behavioral characteristics, according to an embodiment of the disclosure;

FIG. 10 is a detailed flowchart of a method for performing user authentication, according to an embodiment of the disclosure;

FIG. 11 illustrates an example of obtaining user behavioral characteristics, according to an embodiment of the disclosure; and

FIG. 12 illustrates an example of accuracy for a plurality of cases in which additional authentication is performed, according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Throughout the specification, the term “include (or including)” or “comprise (or comprising)” is inclusive or open-ended and does not exclude additional, unrecited components or method steps, unless otherwise described. Also, the term “ . . . ers/ors” used herein refers to hardware components, such as field-programmable gate arrays (FPGAs) or application-specific integrated circuits (ASICs), that perform certain functions. However, the term “ . . . er/or” is not limited to software or hardware. The term “ . . . er/or” may be configured in an addressable storage medium or may be configured to reproduce one or more processors. Thus, for example, the term “ . . . ers/ors” may refer to components, such as software components, object-oriented software components, class components, and task components, and may include processes, functions, attributes, procedures, subroutines, segments of program code, drivers, firmware, micro code, circuits, data, a database, data structures, tables, arrays, or variables. The functionality provided in components and “ . . . ers/ors” may be combined into fewer components and “ . . . ers/ors” may be further separated into additional components and “ . . . ers/ors.”

Embodiments of the disclosure will now be described in detail with reference to accompanying drawings to be readily practiced by those of ordinary skill in the art. In addition, in order to clearly describe the disclosure, parts not related to the description of the disclosure are omitted in the drawings.

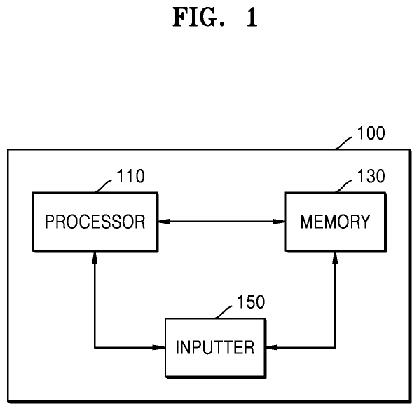

FIG. 1 is a structural diagram of a device for performing user authentication, according to an embodiment of the disclosure.

According to an embodiment of the disclosure, a user authentication device 100 may include a processor 110, a memory 130, and an inputter 150.

The inputter 150 may receive a user input for basic authentication from a user of the device 100.

In the disclosure, the device 100 may be any electronic device that requires user authentication, among mobile devices, such as smartphones, laptop computers, and smart pads, or wired devices, such as desktop computers, smart TVs, and various home appliances.

In the disclosure, basic authentication may refer to general user authentication, such as password input, face recognition, fingerprint recognition, and pattern input. Basic authentication may be performed through various types of user interfaces.

The inputter 150 may refer to an input means, such as a touch pad, a touch screen, a keyboard, a microphone, a fingerprint recognizer, and a camera.

The processor 110 may obtain behavioral characteristics with which the user uses the device 100, and when the user has passed the basic authentication, may perform additional authentication for the user by applying the obtained behavioral characteristics to a first learning model.

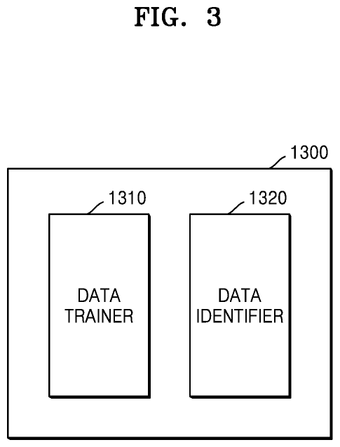

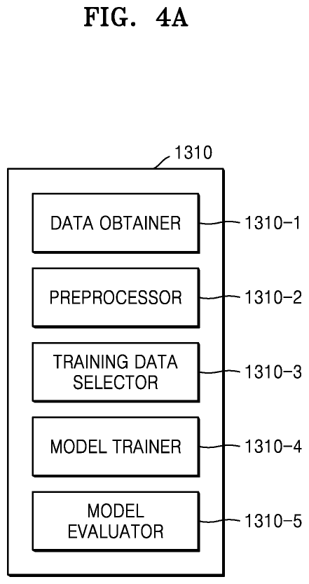

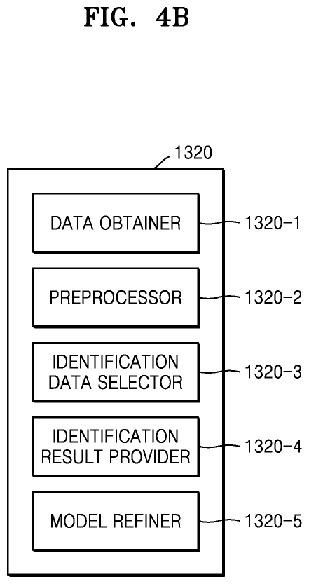

The first learning model may be a model trained to perform additional authentication for a user, based on at least one of a plurality of behavioral characteristics of an authenticated user, accumulated in the device 100. A detailed description of the first learning model will be provided below with reference to FIGS. 3, 4A, and 4B.

The processor 110 may perform additional authentication for the user by obtaining behavioral characteristics with which the user uses the device 100 automatically or as a background operation not requiring an additional action from the user.

In some embodiments, when there is an error in a result of performing additional authentication, the processor 110 may update the first learning model. The processor 110 may receive feedback on the result of performing additional authentication from the user. When there is an error in the result of performing additional authentication, the processor 110 may update the behavioral characteristics of the authenticated user by using obtained user behavioral characteristics.

In some embodiments, the processor 110 may obtain context information about a situation in which user authentication is performed, and determine behavioral characteristics of the user according to the obtained context information. For example, when a user is lying down, by using pre-stored information about behaviors frequently taken by the user while lying down, it may be identified whether the user takes the behaviors. The processor 110 may determine user behavioral characteristics to be identified when the user is lying down.

In some embodiments, the processor 110 may assign a weight to each of the plurality of behavioral characteristics of the authenticated user, accumulated in the device. For example, when there are a plurality of behaviors frequently taken by the user while lying down, the processor 110 may perform additional authentication by applying different weights to a plurality of behavioral characteristics considering the frequency of appearance or accuracy.

The memory 130 may store program instructions that cause the processor 110 to be executed. The memory 130 stores instructions readable and executable by the processor 110 when executed by the processor 110, such that the processor 110 may execute operations included in the user authentication method.

In an embodiment, the memory 130 may store the first learning model.

In another embodiment, the first learning model may also be stored in an external device.

In some embodiments of the disclosure, the user authentication device 100 may include a plurality of memories.

In the embodiment, the processor 110, the memory 130, and the inputter 150 are described as separate structural units, but in some embodiments of the disclosure, the processor 110, the memory 130, and the inputter 150 may also be combined and implemented as the same structural unit.

Also, in the embodiment, the processor 110, the memory 130, and the inputter 150 are described as structural units adjacent to the inside of the user authentication device 100, but apparatuses responsible for respective functions of the processor 110, the memory 130, and the inputter 150 do not need to be physically adjacent to the inside of the device 100, and thus, according to embodiments, the processor 110, the memory 130, and the inputter 150 may be distributed.

In addition, because the user authentication device 100 is not limited to a physical apparatus, some of the functions of the user authentication device 100 may be implemented by software rather than hardware.

According to some embodiments of the disclosure, the user authentication device 100 may further include an outputter, a communication interface, and various sensors.

Each of the components described herein may include one or more components, and the name of a corresponding component may vary depending on the type of the device 100. In various embodiments, the device 100 may be configured to include at least one of the components described herein, and some components may be omitted or additional components may be further included. Also, according to various embodiments, some of the components of the device 100 are combined to form a single entity, such that functions of corresponding components before being combined may be identically performed.

In another embodiment, a user computing device may include separate hardware units. In this embodiment, each hardware unit may be responsible for each operation or sub-operation of the method of the disclosure.

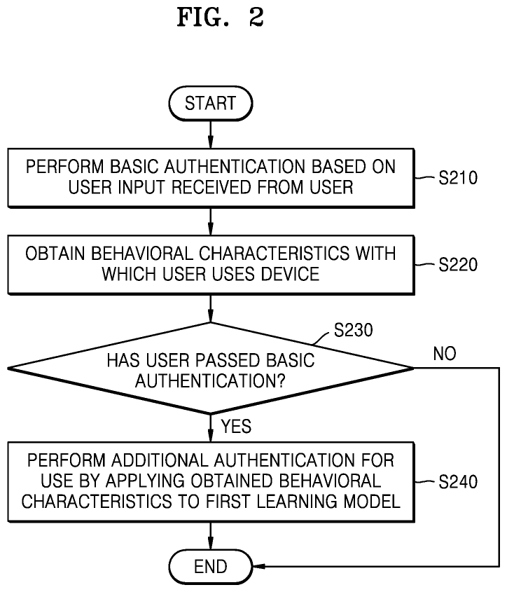

FIG. 2 is a flowchart of a method for performing user authentication, according to an embodiment of the disclosure.

In operation S210, the user authentication device 100 may perform basic authentication based on a received user input.

The basic authentication may refer to a login procedure usually performed to use a service.

The user authentication device 100 may receive user inputs by providing various types of user interfaces to a user.

In operation S220, the user authentication device 100 may obtain behavioral characteristics with which the user uses the device 100.

The user authentication device 100 may perform operation S220 automatically or in the background not requiring an additional action from the user, by obtaining a method by which a user holds the device, a behavioral characteristic during an input process for basic authentication, etc.

Behavioral characteristics with which the user uses the device may be obtained from at least one of at least one sensor, a user interface, or an application. Behavioral characteristics of the user obtained from the application may include a usage method, a habit, and frequently used information for the user who uses a specific application.

The behavioral characteristics with which the user uses the device 100 may include at least one of a user's keyboard typing pattern, a keyboard heat map, a small motion while a user is typing or swiping, a typing timing, a touch screen swiping pattern, a touch input pattern, a context-dependent motion characteristic, behavioral information obtained through an acceleration sensor or a gravity sensor, an application usage habit, or a device grip pattern.

In operation S230, the user authentication device 100 may identify whether the user has passed the basic authentication.

Although it has been described in the embodiment that operation S230 is executed after operation S220, operation S230 may be executed before operation S220 in another embodiment.

When the user has passed the basic authentication, the user authentication device 100 may perform additional authentication for the user by applying the behavioral characteristics obtained in operation S220 to a first learning model (operation S240).

The first learning model may be a model trained to perform additional authentication for a user, based on at least one of a plurality of behavioral characteristics of an authenticated user, accumulated in the device 100. The plurality of behavioral characteristics of the authenticated user, accumulated in the device 100, may be obtained, and stored, automatically when the authenticated user uses the device 100 or manually according to a user input of the authenticated user.

In some embodiments, the first learning model is a model trained to perform additional authentication for the user, based on at least one of context information and the plurality of behavioral characteristics of the authenticated user, accumulated in the device 100, and the context information may refer to at least one of a user's movement state, a user's posture, a location in which user authentication is performed, or a time when user authentication is performed. The context information may refer to situation information, such as a location, time, date, and day of the week, in which user authentication is executed, or state information, such as whether a user is sitting, lying, walking, or running at the moment when user authentication is executed. In this case, the user authentication device 100 may perform the additional authentication based on at least one of behavioral characteristics of the user according to the context information. A detailed description of the first learning model will be provided below with reference to FIGS. 3, 4A, and 4B.

When the user has not passed the basic authentication, the user authentication device 100 may end a user authentication procedure without performing additional authentication.

FIG. 3 is a block diagram of a processor according to an embodiment of the disclosure.

A processor 1300 (i.e., the processor 110 of the user authentication device 100) may apply user characteristics obtained from a user to a first learning model by using an artificial intelligence (AI) system, and perform additional authentication for the user.

The AI system is a computer system in which a machine learns, determines, and becomes smarter by itself, unlike an existing rule-based smart system. The more the AI system is used, the higher the accuracy may be.

For example, a data trainer 1310 may determine unique behavioral characteristics of a user by analyzing various behaviors of the user obtained when the user uses the device 100, and detecting behavioral characteristics of the user from a result of the analysis.

As another example, the data trainer 1310 may determine unique behavioral characteristics of a user for each situation according to each piece of context information, by obtaining context information, such as a user's movement state, a user's posture, a location in which user authentication is performed, or a time when user authentication is performed, and detecting user behavioral characteristics for each situation according to the obtained context information.

The data trainer 1310 may train references for determination by obtaining data to be used for training, and applying the obtained data to a data identification model to be described below.

A data identifier 1320 may determine a situation based on data. The data identifier 1320 may detect and identify behavioral characteristics of a user to be subject to user authentication, by using the trained data identification model. Such identification may be for user behavioral characteristics obtained in a process in which a user performs basic authentication.

The data identifier 1320 may identify behavioral characteristics of a user to be subject to additional authentication by obtaining certain data according to a preset reference through training, and using the data identification model with the obtained data as an input value.

Also, a resultant value output by the data identification model with the obtained data as the input value may be used to refine the data identification model.

At least one of the data trainer 1310 or the data identifier 1320 may be manufactured in the form of at least one hardware chip and be mounted in an electronic device. For example, at least one of the data trainer 1310 or the data identifier 1320 may be manufactured in the form of a dedicated hardware chip for AI or as part of an existing general-purpose processor (e.g., a central processing unit (CPU) or application processor (AP)) or a dedicated graphics processor (e.g., a graphics processing unit (GPU)) and may be mounted in various electronic devices as described above.

The data trainer 1310 and the data identifier 1320 may be mounted in one electronic device, or be respectively mounted in different electronic devices. For example, one of the data trainer 1310 and the data identifier 1320 may be included in one electronic device while the other may be included in a server. Also, model information established by the data trainer 1310 may be provided to the data identifier 1320 and data input to the data identifier 1320 may be provided as additional training data to the data trainer 1310 by wire or wirelessly.

Moreover, at least one of the data trainer 1310 or the data identifier 1320 may be implemented as a software module. When the at least one of the data trainer 1310 and the data identifier 1320 is implemented as a software module (or a program module including instructions), the software module may be stored in a non-transitory computer-readable medium. Also, in this case, at least one software module may be provided by an operating system (OS) or a certain application. Alternatively, some of the at least one software module may be provided by an OS, and some others may be provided by a certain application.

In some embodiments, the user authentication device 100 and the server may effectively distribute and perform operations for training and data identification of the data identification model, and accordingly, in order to provide a service conforming to a user's intention, data processing may be efficiently performed, and the user's privacy may be effectively protected.

FIG. 4A is a block diagram of a data trainer according to an embodiment of the disclosure.

According to some embodiments, the data trainer 1310 may include a data obtainer 1310-1, a preprocessor 1310-2, a training data selector 1310-3, a model trainer 1310-4, and a model evaluator 1310-5.

The data obtainer 1310-1 may obtain data required for determining a situation. The data obtainer 1310-1 may obtain data required for training for determining the situation.

The preprocessor 1310-2 may preprocess the obtained data so that the obtained data may be used for training for determining the situation. The preprocessor 1310-2 may process the obtained data into a preset format so that the model trainer 1310-4 to be described below is able to use the obtained data for training for determining the situation.

The training data selector 1310-3 may select data required for training from among the preprocessed data. The selected data may be provided to the model trainer 1310-4. The training data selector 1310-3 may select data required for training for determining the situation from among the preprocessed data based on a preset reference. Alternatively, the training data selector 1310-3 may select data based on the preset reference through training by the model trainer 1310-4 to be described below.

The model trainer 1310-4 may train references regarding how to determine the situation based on training data. Also, the model trainer 1310-4 may train references regarding which training data needs to be used for determining the situation.

The model evaluator 1310-5 may input evaluation data to the data identification model, and enable the model trainer 1310-4 to perform training again when an identification result output from the evaluation data fails to satisfy a certain reference. In this case, the evaluation data may be preset data for evaluating the data identification model.

FIG. 4B is a block diagram of a data identifier according to an embodiment of the disclosure.

According to some embodiments, the data identifier 1320 may include a data obtainer 1320-1, a preprocessor 1320-2, an identification data selector 1320-3, an identification result provider 1320-4, and a model refiner 1320-5.

The data obtainer 1320-1 may obtain data required for determining the situation, and the preprocessor 1320-2 may preprocess the obtained data so that the obtained data may be used for determining the situation. The preprocessor 1320-2 may process the obtained data into a preset format so that the identification result provider 1320-4 to be described below is able to use the obtained data for determining a situation.

The identification data selector 1320-3 may select data required for training for determining the situation from among the preprocessed data. The selected data may be provided to the identification result provider 1320-4. The identification data selector 1320-3 may select some or all of the preprocessed data based on a preset reference for determining the situation. Alternatively, the identification data selector 1320-3 may select data based on the preset reference through training by the model trainer 1310-4 to be described below.

The identification result provider 1320-4 may determine the situation by applying the selected data to the data identification model. The identification result provider 1320-4 may provide an identification result according to a data identification purpose. The identification result provider 1320-4 may apply the selected data to the data identification model by using the data selected by the identification data selector 1320-3 as an input value. Furthermore, the identification result may be determined by the data identification model.

The model refiner 1320-5 may refine the data identification model based on evaluation on the identification result provided by the identification result provider 1320-4. For example, the model refiner 1320-5 may enable the model trainer 1310-4 to refine the data identification model by providing the identification result provided by the identification result provider 1320-4 to the model trainer 1310-4.

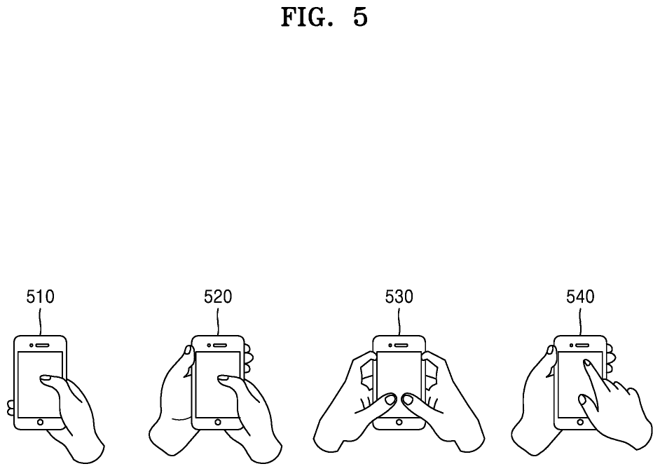

FIG. 5 is a diagram illustrating an example of user behavioral characteristics, according to an embodiment of the disclosure.

A user behavioral characteristic that may be used by the user authentication device 100 may include a method of holding the device 100 and inputting information.

For example, a method for a user to hold the device 100 may include a method 510 of holding the device 100 with one hand and inputting information with the hand holding the device 100, a method 520 of supporting the device 100 with one hand and inputting information with the thumb of the other hand, a method 530 of supporting the device 100 with both hands and inputting information using both thumbs, and a method 540 of supporting the device 100 with one hand and inputting information with the index finger of the other hand.

If, among behavioral characteristics of a certain user, a method of holding the device 100 and inputting information is unique and the frequency of appearance of such a behavioral characteristic is very high, the method of holding the device 100 and inputting information may be an effective additional authentication means for the user.

Also, in the embodiment, the method of holding the device 100 and inputting information has been simply classified into four types, but is not limited thereto, and there may be many other methods of holding the device 100 and inputting information.

Also, although the user authentication device 100 has been illustrated as a smartphone in the embodiment, the user authentication device 100 is not limited to a smartphone.

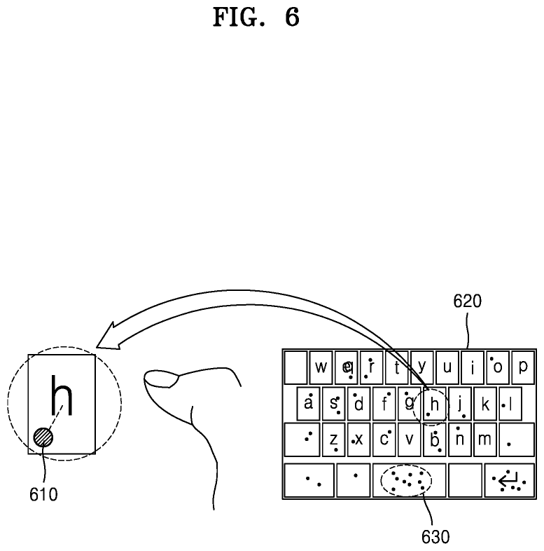

FIG. 6 is a diagram illustrating an example of user behavioral characteristics, according to an embodiment of the disclosure.

A user behavioral characteristic that may be used by the user authentication device 100 may include a keyboard input pattern.

In detail, the keyboard input pattern may include a keyboard heat map 620.

For example, the user authentication device 100 may detect, from the keyboard heat map 620, user behavioral characteristics, such as a position at which a user presses a specific button, and a distance or a relative position between the center of each keyboard button and a portion of the button where the user touches the button.

For example, when a user in the embodiment presses a space bar on a keyboard, the user may usually show a behavioral characteristic of pressing a position 630.

As another example, when the user in the embodiment presses an H button on the keyboard, the user may show a behavioral characteristic of pressing a portion 610 in the lower left direction from the center of the H button. Because there may be differences according to a user's keyboard typing habits and a user's finger length, this may be a means for additional authentication.

However, a method of additionally authenticating the user with the keyboard input pattern is not limited thereto, and other methods, such as the strength of typing on the keyboard and a contact area of a button, may be used.

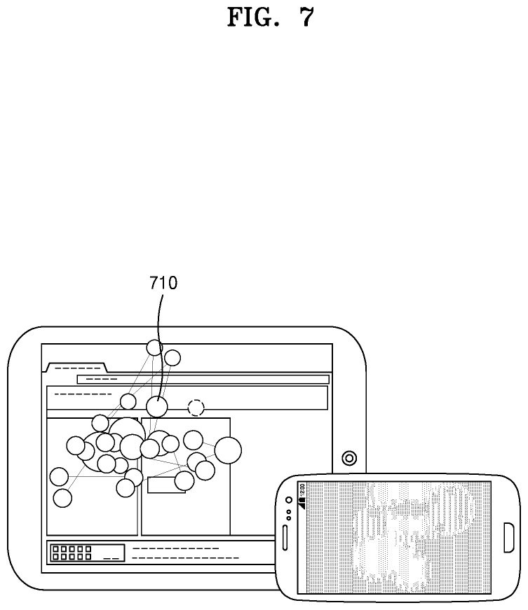

FIG. 7 is a diagram illustrating an example of user behavioral characteristics, according to an embodiment of the disclosure.

A user behavioral characteristic that may be used by the user authentication device 100 may include a touch screen input pattern.

In detail, the touch screen input pattern may include a touch screen heat map 710.

For example, the user authentication device 100 may detect, from the touch screen heat map 710, user behavioral characteristics, such as a position at which a user usually touches the touch screen, and a swiping method.

For example, when a user in the embodiment touches the touch screen, the user may usually show a behavioral characteristic of pressing around a position on the touch screen heat map 710.

However, a method of additionally authenticating the user with the touch screen input pattern is not limited thereto, and the strength of touching the touch screen, a contact area of the touch screen, a swiping shape and length, etc., may be used.

In another embodiment, the keyboard input pattern may be used together with a grip position of the device 100.

Also, although the user authentication device 100 has been illustrated as a smartphone or a smart pad in the embodiment, the user authentication device 100 is not limited to a smartphone or a smart pad.

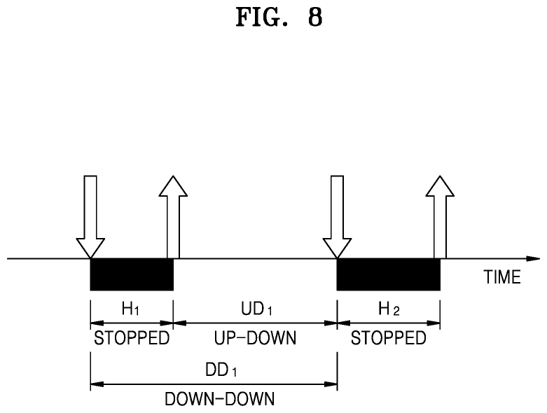

FIG. 8 is a diagram illustrating an example of user behavioral characteristics, according to an embodiment of the disclosure.

A user behavioral characteristic that may be used by the user authentication device 100 may include a keyboard typing pattern.

The typing pattern may be a user-specific behavioral characteristic detected by analyzing an amount of time DD1 taken to press another key after a specific key is pressed, periods H1 and H2 for which a specific key is pressed down, an amount of time UD1 taken to press another key after pressing of a specific key is released, etc.

A password input to log into a service is information frequently input by a user, and accordingly, the user's input pattern or speed is highly likely to be constant.

The typing pattern may be updated with more accurate information as the user's usage time of the device 100 increases.

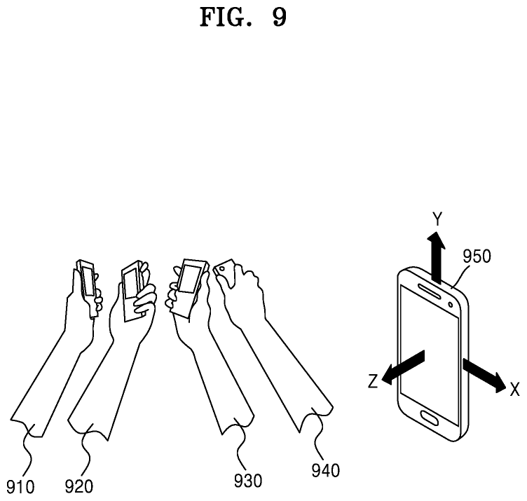

FIG. 9 is a diagram illustrating an example of user behavioral characteristics, according to an embodiment of the disclosure.

A user behavioral characteristic that may be used by the user authentication device 100 may include an angle at which the device is tilted when a user uses the device 100, a small motion detected while the user uses the device 100, or the like.

The angle at which the device 100 is tilted and the small motion detected while the user uses the device 100 may be detected by using various sensors, such as an accelerometer or a gyroscope.

The angle at which the device 100 is tilted may vary depending on an angle or a direction in which the user holds the device 100, as shown in 910, 920, 930, and 940. The angle at which the device 100 is tilted may be a degree to which the device 100 is tilted in each of X, Y, and Z directions, as shown in 950.

In some embodiments, the user authentication device 100 may detect a change in the angle at which the device 100 is tilted while the user types or swipes, and may use the same as a user behavioral characteristic for additional authentication.

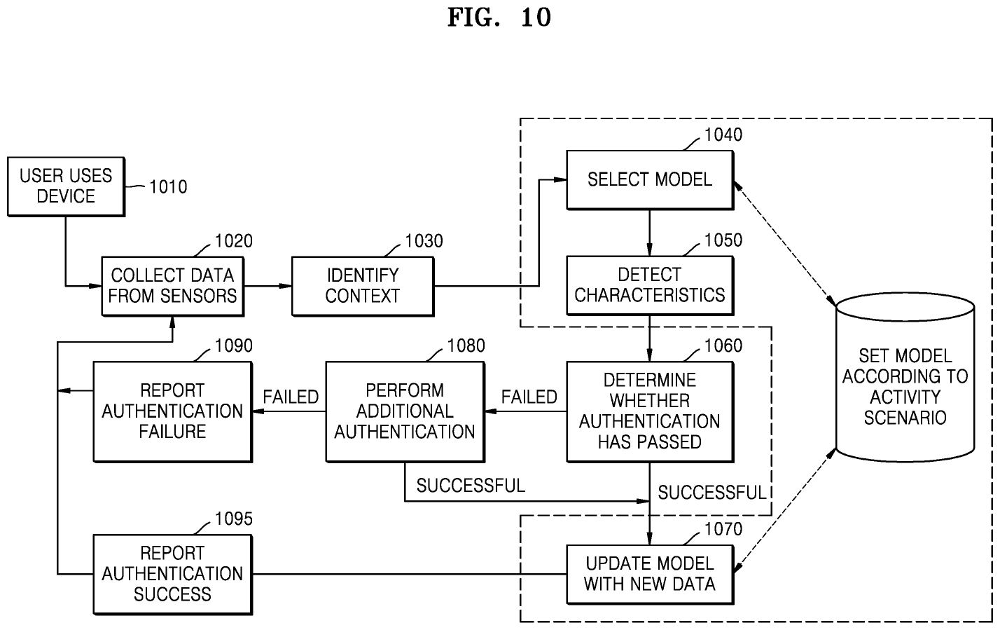

FIG. 10 is a detailed flowchart of a method for performing user authentication, according to an embodiment of the disclosure.

In operation 1010, the user authentication device 100 may be used by a user in various manners. The user authentication device 100 may be used by the user in various manners over a long period of time.

In operation 1020, the user authentication device 100 may collect data on behavioral characteristics of the user from sensors while the user uses the user authentication device 100.

In operation 1030, the user authentication device 100 may obtain context information while the user uses the user authentication device 100. The context information may refer to at least one of a user's movement state, such as walking, running, and being stationary, a user's posture, such as sitting, lying down, and standing, a location in which user authentication is performed, or a time when user authentication is performed. However, the context information is not limited thereto.

In operation 1040, the user authentication device 100 may select a behavioral characteristic model based on the obtained context information.

For example, when the obtained context information indicates that the user is running, the user authentication device 100 may select a behavioral characteristic model that may be detected while the user is running. Models set in advance according to an activity scenario may be used to select a behavioral characteristic model.

In operation 1050, the user authentication device 100 may detect user behavioral characteristics corresponding to the selected model.

In operation 1060, the user authentication device 100 may determine whether the user is authenticated as a valid user, by comparing the behavioral characteristics of the user collected in operation 1020 with the user behavioral characteristics detected in operation 1050.

When the authentication is successful, in operation 1070, the user authentication device 100 may update a user behavioral characteristic model by using the behavioral characteristics of the user, collected in operation 1020, as new data. As the update is repeated, the accuracy of user authentication may be increased.

When the authentication fails, in operation 1080, the user authentication device 100 may perform additional authentication by using another means.

When the additional authentication in operation 1080 is successful, in operation 1070, the user authentication device 100 may update the user behavioral characteristic model by using the behavioral characteristics of the user, collected in operation 1020, as new data.

When the additional authentication in operation 1080 fails, in operation 1090, the user authentication device 100 may report an authentication failure to the user.

When the authentication is successful, in operation 1095, the user authentication device 100 may report an authentication success to the user.

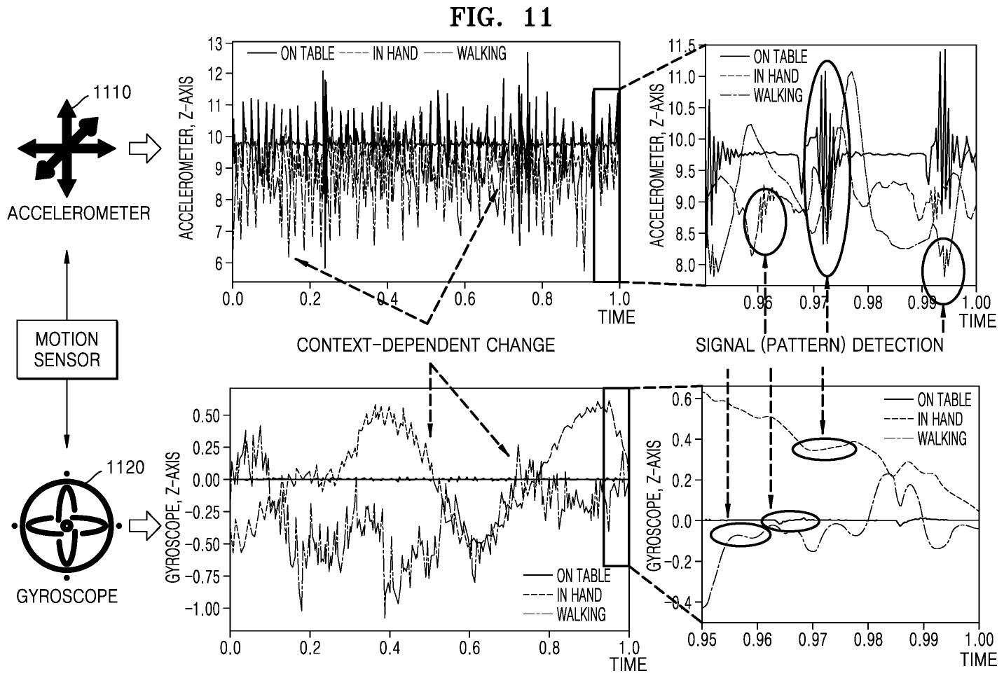

FIG. 11 illustrates an example of obtaining user behavioral characteristics, according to an embodiment of the disclosure.

In the embodiment, an accelerometer 1110 and a gyroscope 1120 are used to detect a user behavioral characteristic for each of user motion states, such as a case in which the device 100 is placed on a table, a case in which the device 100 is held in a user's hand, and a case in which a user is walking.

The accelerometer 1110 and the gyroscope 1120 may obtain a change in measured values with time for each of the case in which the device 100 is placed on the table, the case in which the device 100 is held in the user's hand, and the case in which the user is walking, and may detect signal patterns characteristically detected in each motion state based on the obtained change in the measured values.

The user authentication device 100 may perform appropriate additional authentication for the user according to context information, by using the detected signal patterns.

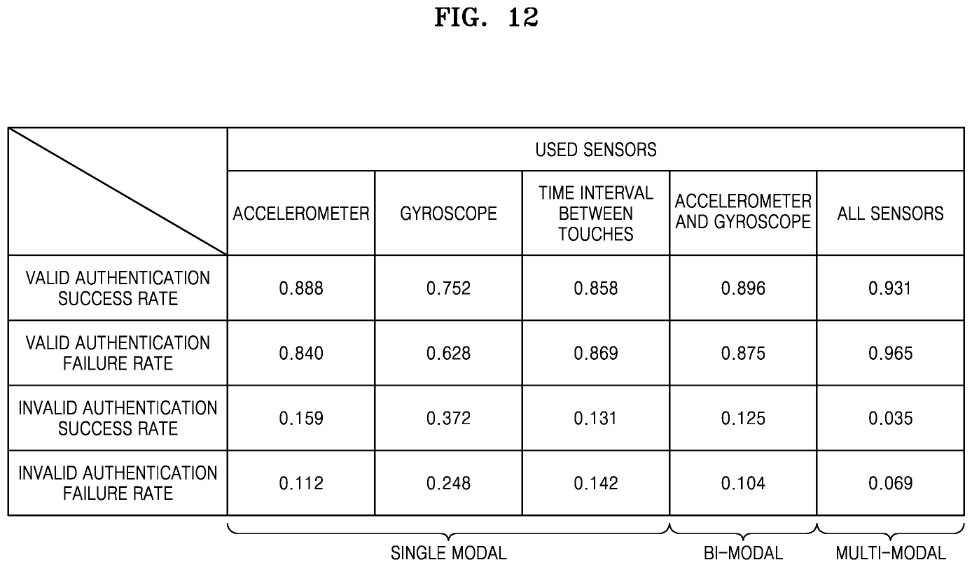

FIG. 12 illustrates an example of accuracy for a plurality of cases in which additional authentication is performed, according to an embodiment of the disclosure.

Accuracy of additional authentication may be increased as a valid authentication success rate or a valid authentication failure rate is high, and an invalid authentication success rate or an invalid authentication failure rate is low.

The valid authentication success rate may refer to a percentage of successful authentication attempts by authorized users, the valid authentication failure rate may refer to a percentage of failed authentication attempts by unauthorized users, the invalid authentication success rate may refer to a percentage of successful authentication attempts by unauthorized users, and the invalid authentication failure rate may refer to a rate of failed authentication attempts by authorized users.

According to an embodiment, in a case in which additional authentication is performed according to one behavioral characteristic among an accelerometer, a gyroscope, and a time interval between touches, the accuracy of additional authentication may be lower than in a case in which additional authentication is performed by using both the accelerometer and the gyroscope.

Also, in the case in which additional authentication is performed according to two behavioral characteristics of the accelerometer and the gyroscope, the accuracy of additional authentication may be lower than in a case in which additional authentication is performed by using all three behavioral characteristics of the accelerometer, the gyroscope, and the time interval between touches.

That is, when additional authentication is performed by using a plurality of behavioral characteristics, the accuracy of additional authentication may be increased as the number of used behavioral characteristics increases.

Considering that the accuracy of additional authentication is increased as the number of user behavioral characteristics used for additional authentication increases, the first learning model described with reference to FIGS. 3, 4A, and 4B may determine the number and type of user behavioral characteristics to be used for additional authentication.

In some embodiments, when a plurality of user behavioral characteristics are used for additional authentication, the user authentication device 100 may perform additional authentication by assigning different weights to the plurality of behavioral characteristics, respectively.

The method of the disclosure may be executed by a processor, an application specific integrated circuit (ASIC), a field programmable gate array (FPGA), or a system-on-chip (SoC). In addition, the method described in the disclosure may be implemented by a storage medium that stores computer-executable instructions, and when executed by a processor in a computer, causes the method of the disclosure to be executed.

A device-readable storage medium may be provided in the form of a non-transitory storage medium. In this regard, the term ‘non-transitory storage medium’ simply means that the storage medium is a tangible device and does not include a signal (e.g., an electromagnetic wave), but this term does not differentiate between where data is semi-permanently stored in the storage medium and where the data is temporarily stored in the storage medium. For example, the ‘non-transitory storage medium’ may include a buffer in which data is temporarily stored.

According to an embodiment of the disclosure, the method according to various embodiments disclosed herein may be included and provided in a computer program product. The computer program product can be traded as a commodity between a seller and a buyer. The computer program product may be distributed in the form of a machine-readable storage medium (e.g., a compact disc read-only memory (CD-ROM)), or be distributed (e.g., downloaded or uploaded) online via an application store (e.g., Play Store™), or between two user devices (e.g., smartphones) directly. In the case of online distribution, at least a part of the computer program product (e.g., a downloadable app) may be temporarily stored or temporarily generated in a device-readable storage medium, such as a memory of a manufacturer server, an application store server, or a relay server.

The above description of the disclosure is provided for illustration, and it will be understood by one of ordinary skill in the art that various changes in form and details may be readily made therein without departing from essential features and the scope of the disclosure as defined by the following claims. Accordingly, the embodiments described above are examples in all aspects and are not limited. For example, respective components described in an integrated form may be dividedly used, and the divided components may be used in a state of being combined.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A user authentication method by which a device authenticates a user, the method comprising:
performing basic authentication based on a received user input;
obtaining behavioral characteristics of the user using the device; and
when the user has passed the basic authentication, performing additional authentication for the user by applying the obtained behavioral characteristics to a first learning model,
wherein the first learning model is a model trained to perform the additional authentication for the user, based on at least one of a plurality of behavioral characteristics of an authenticated user, the behavioral characteristics being accumulated in the device.

2. The method of claim 1, wherein the obtaining of the behavioral characteristics of the user using the device and the performing of the additional authentication for the user are performed in a background not requiring an additional action from the user.

3. The method of claim 1, wherein the behavioral characteristics of the user using the device are obtained from at least one of:
at least one sensor,
a user interface, or
an application.

4. The method of claim 1, wherein the behavioral characteristics of the user using the device comprise at least one of:
a keyboard typing pattern,
a keyboard heat map,
a motion while typing or swiping,
a typing timing,
a touch screen swiping pattern,
a touch input pattern,
a context-dependent motion characteristic,
behavioral information obtained through an acceleration sensor or a gravity sensor,
an application usage habit, or
a device grip pattern.

5. The method of claim 1, further comprising updating the first learning model in response to an error in a result of performing the additional authentication.

6. The method of claim 1, wherein the plurality of behavioral characteristics of the authenticated user, accumulated in the device, are obtained automatically when the authenticated user uses the device or manually according to a user input of the authenticated user.

7. The method of claim 1,
wherein the first learning model is a model trained to perform the additional authentication for the user, based on at least one of context information or the plurality of behavioral characteristics of the authenticated user, accumulated in the device, and
wherein the context information refers to at least one of a movement state of the user, a posture of the user, a location in which the user authentication is performed, or a time when the user authentication is performed.

8. The method of claim 1, wherein the performing of the additional authentication for the user by applying the obtained behavioral characteristics to the first learning model comprises:
obtaining context information about a situation in which the user authentication is performed; and
determining a behavioral characteristic of the user associated with the obtained context information.

9. The method of claim 1, wherein a weight is assigned to each of the plurality of behavioral characteristics of the authenticated user, accumulated in the device.

10. A user authentication device comprising:
an inputter configured to receive a user input for basic authentication from a user;
a memory storing one or more instructions; and
a processor configured to:
execute the one or more instructions to obtain behavioral characteristics of the user using the device, and
when the user has passed the basic authentication, perform additional authentication for the user by applying the obtained behavioral characteristics to a first learning model,
wherein the first learning model is a model trained to perform the additional authentication for the user, based on at least one of a plurality of behavioral characteristics of an authenticated user, the behavioral characteristics being accumulated in the device.

11. The device of claim 10, wherein the processor is further configured to:
obtain the behavioral characteristics of the user using the device, as a background operation not requiring an additional action from the user; and
perform the additional authentication for the user.

12. The device of claim 10, wherein the behavioral characteristics of the user using the device are obtained from at least one of:
at least one sensor,
a user interface, or
an application.

13. The device of claim 12, wherein the behavioral characteristics of the user using the device comprise at least one of:
a keyboard typing pattern,
a keyboard heat map,
a motion while typing or swiping,
a typing timing,
a touch screen swiping pattern,
a touch input pattern,
a context-dependent motion characteristic,
behavioral information obtained through an acceleration sensor or a gravity sensor,
an application usage habit, or
a device grip pattern.

14. The device of claim 10, wherein the processor is further configured to update the first learning model in response to an error in a result of performing the additional authentication.

15. A non-transitory computer-readable recording medium having recorded thereon a program for executing the user authentication method of claim 1 on a computer.
